(19) United States
(12) Patent Application Publication
(10) Pub. No.: US 2012/0168189 A1
(43) Pub. Date: Jul. 5, 2012

(54) Rechargeable Battery-Operated Screwing System with a Reduced Volume of Radio-Transmitted Data

(75) Inventor: Martin Eckert, Neuenstein (DE)

(73) Assignee: Robert Bosch GmbH, Stuttgart (DE)

(21) Appl. No.: 13/339,792

(22) Filed: Dec. 29, 2011

(30) Foreign Application Priority Data
Dec. 29, 2010 (DE) 10 2010 056 525.3

(51) Int. Cl. G06F 19/00

(52) U.S. Cl. 173/1; 173/2

(57) ABSTRACT

The disclosure relates to a method for using a rechargeable battery-operated screwing system which is suitable for establishing screw connections by means of a motor-driven working spindle. The rechargeable battery-operated screwing system having communication devices for wirelessly transmitting data for defining screwing curves, which describe a screwing process, between a screwing spindle module and an evaluation module, with at least two variables which are characteristic of the screwing curve being wirelessly transmitted by means of the communication devices and at least one further variable which is relevant for the screwing curve being calculated from the transmitted data by the evaluation module.

The invention relates to a method for using a rechargeable battery-operated screwing system which is suitable for establishing screw connections by means of a motor-driven working spindle, with the rechargeable battery-operated screwing system having communication devices for wirelessly transmitting data, in particular result data, for defining screwing curves, which describe a screwing process, between a screwing spindle module and an evaluation module, and also to a rechargeable battery-operated screwing system which is suitable for establishing screw connections by means of a motor-driven working spindle, with the rechargeable battery-operated screwing system having communication devices for wirelessly transmitting data for defining and therefore also for documenting screwing curves, which describe a screwing process, between a screwing spindle module and an evaluation module.

Screw connections have provided a possible way of connecting workpieces to one another in many areas for a long time. Advantages of screw connections are, in particular, the ability to release the connection and the ability to adjust the force with which the screwing element (for example a screw, a bolt or others) is screwed into the workpiece or into a mating piece (for example a nut) which has a complementary internal thread. These advantages mean screw connections are a connection variant which is very often used in modern production processes too. Even when producing complex products, for example in automotive or machine construction, a large number of different screw connections are created between different individual parts during production on appropriate assembly lines. These individual parts can have different material properties which are the result, for example, of a different material composition, material thickness, material treatment, surface coating and others. The forces which act on the respective screw connection also often differ to a great extent within one product. Accordingly, it is necessary for screw connections with a very wide variety of connection strengths to be established along one assembly line.

This can be ensured by subjecting the screwing element, referred to simply as a screw in the text which follows, to a prespecified minimum torque. It is thereby possible to ensure that the connection has the required strength. However, care should be taken in the process that the the torque does not exceed a maximum value since this can damage the screw connection, and this would in turn lead to a reduction in the connection strength. Therefore, in many fields of application, it is essential to monitor the torque which is applied to a screw connection for the purpose of assessing the quality and functionality of said screw connection.

In the case of complex products of which the individual parts are connected to one another by a large number of screw connections, it is very difficult to in each case accurately maintain the torque which is provided for establishing the screw connection. It would be necessary, for example, to use a torque wrench which is intended specifically for this screw connection along an assembly line for each screw connection which needs to be tightened with a specific torque. Since this cannot be implemented efficiently in practice, some screwing systems which make it possible to adjust the torque to the respective requirements have already been developed.

Rechargeable battery-operated screwing systems which establish screw connections by means of a motor-driven working spindle have proven particularly suitable. These rechargeable battery-operated screwing systems usually have a rechargeable battery or a battery which supplies electrical energy to an electric motor so that said electric motor can move or drive the components accordingly used for performing the work. In this case, the torque for the respective screw connection can be adjusted as a function of the specific requirements. The torque which is provided for the respective process or a set of torques is usually stored in the screwing system, for example with the aid of a parameterizing interface (operator control program). It is only rarely necessary to change these values, and therefore the associated volume of data is not normally particularly significant in this process. New prespecified torques may also be input directly to the screwing system.

In order to meet the requirements of modern process control and quality assurance, further developments of these screwing systems comprise communication devices for wirelessly transmitting data which represents, for example, the situation of the prespecified torque value being reached in the respective screwing process and possibly even the profile of the screwing curve which has led to the respective screwing result. This data is usually provided by a screwing spindle module and transmitted to the evaluation module. In this case, it is also possible for both a prespecified torque and also complex screwing curves which describe different torques and angular speeds of the working spindle over the entire screwing process to be transmitted.

In the meantime, screwing systems which can also define and execute a series of different screwing processes have entered the market. It is necessary, particularly in this case, for the screwing process which has been performed to be documented and to be able to be documented by the evaluation module for quality control and to be able to be stored for any possible subsequent queries. The information about the screwing process which has been executed is provided to the evaluation module for each of the large number of screwing processes which has been executed with this screwing spindle module, so that a large volume of data is transmitted in total. Each screwing process can contain, for example, information about the screw head used and the torques which are present at specific times of the screwing process. Since the ascertained torques can change over the course of a screwing process, a large volume of data may be transmitted in this case.

If this communication is wireless, the transmission of the complex information about the execution of the screwing process produces a considerable volume of data which requires an increased transmission power both when it is being transmitted and when it is being received. This presents a significant restriction on the performance of the screwing spindle module, particularly in the screwing spindle module, since the screwing spindle module is usually a rechargeable battery-operated device of which the operating time is reduced by the energy required for the energy-intensive transmission processes.

It is therefore desirable to reduce the energy which has to be expended for the transmission and reception processes and to therefore make available a greater proportion of the rechargeable battery capacity for the screwing processes. The object of the invention is to reduce the energy expenditure on transmitting and receiving data over the executed screwing process in order to be able to carry out more screwing processes for each charge of the rechargeable battery.

This object is achieved by the subjects of the independent patent claims.

One essential aspect of the invention is a method for using a rechargeable battery-operated screwing system which is suitable for establishing screw connections by means of a motor-driven working spindle, with the rechargeable battery-operated screwing system having communication devices for wirelessly transmitting data, in particular result data, for defining screwing curves, which describe a screwing process, between a screwing spindle module and an evaluation module, with at least two variables which are characteristic of the screwing curve being wirelessly transmitted by means of the communication devices and the data which is to be transmitted being modified by the screwing spindle module by calculating at least one variable which is relevant for characterizing the screwing curve. An entire data record or a large number of pairs of values is preferably calculated.

By virtue of this method, it is possible to considerably reduce the time which is required for the wireless data transmission. The data records which usually comprise pairs of torque/angle or torque/time values can be back-calculated from the transmitted data in the evaluation module. In this case, the transmitted data can comprise, for example, a start angle, a time value, a sample rate, a rotation speed or others. The pair of torque/angle and/or torque/time values can be back-calculated from the transmitted values for each time point in the evaluation module and the entire screwing process can therefore be followed in detail and documented.

The screwing spindle module is preferably a control module, that is to say preferably an autonomous computer unit, having a motor and a spindle which implements stored screwing parameters (comprising, for example, screwing-in speed, switch-off torque, switch-off angle, monitoring limit, amongst others), also called screwing programs, on the screwing spindle module. In this context, “implements” means that the spindle motor is adjusted to the desired rotation speed and torque/angle/gradient/time values are detected, these being compared with the target parameters and stored in a screwing curve. The ascertained screwing curves is transmitted to a superordinate control module (for example a master computer in the assembly line) after the screwing operation.

In a preferred embodiment of the invention, the screwing curve is divided into individual stages, and characteristic values for the start angle and start time or sample rate are each advantageously transmitted for each stage. As a result, it is possible to calculate the pairs of torque/angle and/or torque/time values of each, for example linear, section (of each stage) of the screwing curve. Consequently, it is necessary to transmit only a small amount of data, particularly in the case of relatively simple screwing curves. However, the volume of data which is to be transmitted can also be considerably reduced in the case of highly complex screwing curves. In this case, it is possible to also calculate non-linear screwing curves or stages of a screwing curve. It is also possible, for example, to calculate a precisely defined acceleration curve by means of its start values. A precondition is that the curve profile within each of the individual stages is continuous.

A data record which is to be transmitted is preferably calculated from the screwing curve by the screwing spindle module in a first step after the data is transmitted, and this data which is characteristic of the screwing curve is transmitted to the evaluation module in a subsequent second step. It is also possible for the transmitted or calculated data to be, possibly temporarily, stored within the screwing spindle module in order to allow subsequent (possibly renewed) transmission of the data record. The result data from the screwing operations is stored by the screwing spindle module. Result data includes, amongst others, torque/angle pairs in a defined angular resolution or torque/time pairs in a defined time resolution. When there is an existing radio infrastructure and given a corresponding configuration, data is preferably transmitted to a superordinate control module (or an evaluation module) which is preferably connected to the company network.

In order to design the method to save as much energy as possible and therefore to make the working time which is available with a rechargeable battery charge to be as long as possible, in a preferred variant of the method, the wireless transmission of the data between the communication devices is interrupted after the data for defining a screwing curve has been transmitted, as a result of which energy consumption by the communication devices for transmitting the data which is required for defining a screwing curve is reduced.

In a further preferred variant of the method, the pairs of torque/angle and/or torque/time values of a screwing curve within a stage with a constant rotation speed and sample rate are calculated from wirelessly transmitted data for the start angle and start time. The volume of result data can be reduced by the predefined angular and time resolutions if, for example, the start and end values are known. This reduces both the volume of data which is to be transmitted and also the memory required in the screwing spindle module.

In a preferred variant of the method, the time which is taken for transmitting the data which is required in the evaluation module for calculating the pairs of torque/angle and/or torque/time values which characterize the screwing curve is reduced compared with that for transmitting the pairs of torque/angle and/or torque/time values at the same bandwidth.

A further important aspect of the invention is a rechargeable battery-operated screwing system which is suitable for establishing screw connections by means of a motor-driven working spindle, with the rechargeable battery-operated screwing system having communication devices for wirelessly transmitting data for defining and possibly also for documenting screwing curves, which describe a screwing process, between a screwing spindle module and an evaluation module, with the communication devices having means for wirelessly transmitting at least two variables which are characteristic of the screwing curve, and the screwing spindle module has a device for calculating from the data at least one further variable which is relevant for the screwing curve.

A rechargeable battery-operated screwing system of this kind makes it possible to transmit data for describing a screwing curve to the evaluation module in a particularly energy-efficient manner. It is more expedient in respect of energy to calculate the data in the screwing spindle module than to transmit the entire data record. As a result, energy consumption in the screwing spindle module is lower, and therefore a rechargeable battery charge lasts longer and, respectively, can be used for more screwing processes.

In a preferred embodiment of the rechargeable battery-operated screwing system, the wireless data transmission between the communication devices is bidirectional. As a result, information about an executed screwing process and/or the screwdriver attachment used can be transmitted back to the screwing spindle module or another communication device, where this information can then be used for evaluation and quality control purposes.

In a further preferred embodiment, the rechargeable battery-operated screwing system has a device which comprises a microcontroller and which is suitable for dividing a prespecified screwing curve into individual stages which can be defined in each case by the start angle and the start time or sample rate. This device is preferably located in the screwing spindle module or in the communication device in the screwing spindle module. In this device, a prespecified screwing curve is divided in such a way that individual stages are formed which each have a continuous profile. This profile can be described by means of a small amount of data, and therefore it is sufficient to transmit this small amount of data in order to calculate the exact profile of each stage on the evaluation module side of the wireless communication channel. In the evaluation module, these individual calculated stages are combined to form the original screwing curve, and therefore all the information in a screwing curve can be reconstructed for each data item with a considerably reduced volume of data.

In a preferred variant of the rechargeable battery-operated screwing system, the evaluation module has a device by means of which individual stages of a screwing curve and/or the prespecified screwing curve can be calculated from the start angle and start time or sample rate. As already described above, the volume of data which is to be wirelessly transmitted can be considerably reduced if, for each of the stages of a screwing curve which are calculated by the control module, only the data which is relevant for this respective stage is transmitted. This data comprises a component which describes the torque or the change in the torque per unit time. This component is described by the start angle. Information about the time which the respective stage is executed is also required. For this purpose, time values, for example, can be transmitted or the time values can be calculated from, for example, the sample rate. Therefore, a start time or sample rate is preferably transmitted in addition to the start angle.

The respective stage of the screwing curve can be calculated from this transmitted data by means of a device in the evaluation module. In this case, the evaluation module, the communication device in the evaluation module or another component can exhibit these calculation devices and carry out the calculation.

In a preferred embodiment of the rechargeable battery-operated screwing system, the data which can be provided by the screwing spindle module for the wireless data transmission and is constant for and characteristic of individual stages of a screwing curve comprises a start angle value, a rotation speed value and a sample rate value. As already described above, this data is particularly suitable for describing the individual stages of a screwing curve with a sufficient degree of accuracy. When reduced to this data, the volume of data is considerably reduced, without there being any loss of information which is relevant for defining a screwing curve and therefore the screwing process.

Further advantages, objectives and properties of the present invention will be explained with reference to the following description of the appended figures which show, by way of example, a rechargeable battery-operated screwing system according to the invention which is suitable for establishing screw connections by means of a motor-driven working spindle, with the rechargeable battery-operated screwing system having communication devices for wirelessly transmitting data for defining screwing curves, which describe a screwing process, between a screwing spindle module and an evaluation module. Components of the rechargeable battery-operated screwing system which correspond at least substantially in respect of their function in the figures can be identified with the same reference numerals in this case, it not being necessary to number and explain these components in all the figures.

In the drawing:

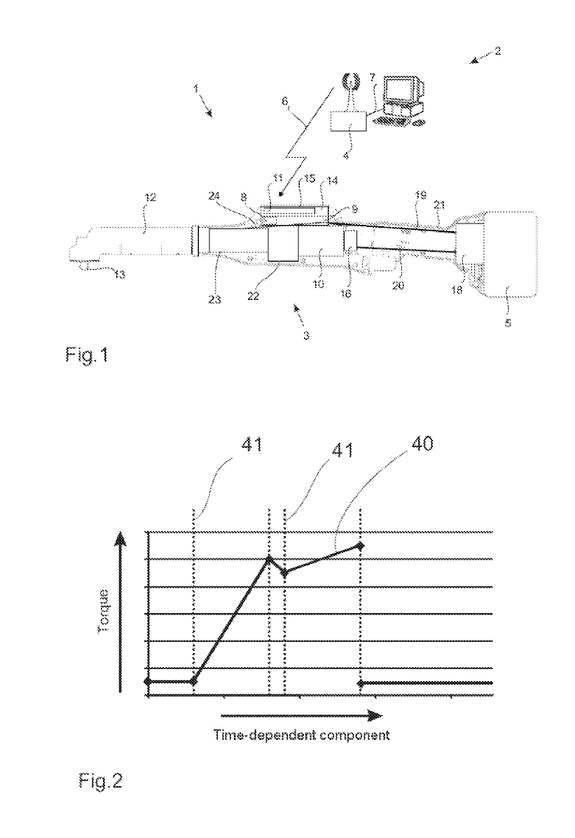

FIG. 1 shows a basic schematic diagram of an embodiment of the tool according to the invention; and

FIG. 2: shows an exemplary screwing curve.

FIG. 2: shows a schematic flowchart for calculating data, transmitting data and back-calculation.

FIG. 1 shows a basic schematic diagram of an embodiment of the screwing system 1 according to the invention. Said screwing system comprises a screwing spindle module 3 and an evaluation module 2 which can communicate wirelessly with one another by means of communication devices 4, 8. In order to be able to ensure the mobility of the screwing spindle module 3, said screwing spindle module is supplied with energy by means of a rechargeable battery 5. In the screwing spindle module 3, the screwing curves which are to be transmitted are processed and prepared for transmission by means of the communication channel 6. To this end, the screwing curve which is to be transmitted is divided into individual segments which can each be clearly characterized on the basis of their curve profile and allow a particularly expedient reduction in the data which is to be transmitted.

The data which is conditioned in this way is transmitted to the radio module 8 and transmitted from this radio module to the evaluation module 2 by means of the wireless communication channel 6. The processing data and the corresponding processing parameters are preferably transmitted by means of a cable-free radio connection 6, for example Bluetooth or WLAN and to the communication device 4, from where the data of a central evaluation module 2 which is preferably connected to the communication device 4 (access point) by means of a cable-bound line 7, for example an LAN line.

The radio module 8 of the screwing spindle module 3 establishes a radio connection 6 by means of this communication device 4, in order to transmit data for describing a stage of a screwing curve from the screwing spindle module 3 to the evaluation module 2. In the evaluation module 2, the signal which is transmitted by the radio module 8 is forwarded to a processing and storage device (not shown). Said processing and storage device preferably comprises a sufficiently powerful microprocessor (not shown) which can back-calculate the screwing curve from the transmitted data.

The radio connection 6 is preferably designed to be bidirectional, so that the radio module 8 can receive feedback about successful transmission by means of this radio connection 6.

The further data from the screwing curve is calculated in the screwing spindle module. In the screwing spindle module 3, the electric motor 10 is actuated by a control device 9 in accordance with the prespecified (stored but possibly variable) values. Like the communication device 8 in the screwing spindle module and the processing and control device 9, said electric motor is supplied with energy by a rechargeable battery 5. Therefore, the less energy is used for other processes, the more energy is available to the electric motor.

The fact that transmission has been executed and details about the transmitted screwing curve can be displayed on a display unit 11, for example on a screen 11. The screen 11 is preferably an energy-efficient display which can also be used for displaying further data which is important for the screwing process. For example, measured processing parameters, such as the rotation speed of the electric motor 10, which has a direct effect on the rotation speed of the working head 13 or processing component 13 which is located in the angle head 12 which is driven by the electric motor 10 are shown by means of this display device 11. By way of example, the remaining capacity of the rechargeable battery 5, the used screwing attachment, the current torque and other data can also be displayed.

Parameters which are frequently used for a screwing process are stored in a memory in the screwing spindle module. This memory is a constituent part of a memory device 14 in which data records can be stored and from which the previously stored data records can be retrieved.

Program data and processing data can be input by means of the input device 15 and transmitted to the control device 9. Modifications to already stored screwing parameters (possibly depending on the authorization of the user) are possible. The target parameter sets are selected manually by means of a display, by a scanner by scanning the ID of the target parameter data record or by means of a superordinate control system. The inputting of data and the input data are displayed to the worker or to the user by means of the display device 11. A complete screwing profile defined by the torque/angle or torque/time pairs as the target parameter set is preferably not provided. Checking for compliance with the target parameters is very complicated, difficult to realize in a technical respect and requires additional rechargeable battery power.

In order to determine the current position of the rotor, a first measuring device 16, for example an angle encoder or rotary encoder 16, is, for example, arranged on the electric motor 10 or connected to said electric motor in such a way that the rotary angle of the rotor and/or the rotary angle of the shaft of the electric motor 10, which shaft is operated by the rotor, can be detected or controlled or the change in said rotary angle relative to a stationary part can be ascertained or controlled, preferably by means of suitable sensors. Said value can be used, for example, as a starting value for calculating the screwing curve.

A gear mechanism 22 is interconnected between the electric motor 10 and a second measuring device 23, it being possible to change the movements or the torque which acts on the shaft by means of said gear mechanism, so that the screwing spindle module 3 which is shown in FIG. 1 can, for example, screw a screw into a workpiece and also unscrew said screw from said workpiece.

A drive electronics system 18, which is arranged on the rechargeable battery 5 so as to be supplied with electrical energy by said rechargeable battery, controls and regulates the drive of the electric motor 10 in order to move the working head 13 as a function of the parameters which are prespecified by the control device 9. If a specific torque is prespecified, for example, by the control device 9 for a specific stage, the supply of energy to the electric motor is regulated by means of the drive electronics system 18 in accordance with the prespecified values.

Control data is preferably transmitted in a cable-bound manner by means of a two-part line 19 or supply line 19 between the control device 9 and the drive electronics system 18 or the rechargeable battery 5. This line is preferably also suitable for providing electrical energy from the rechargeable battery 5 to the control device 9. The first two-part line 19 accordingly has a data line for transmitting the data and/or the signals from the control device 9 to the drive electronics system 18 and a power line for transmitting electrical energy from the rechargeable battery 5 to the control device 9.

A further, preferably cable-bound, second preferably two-part line 20 or supply line 20 is present between the drive electronics system 18 or the rechargeable battery 5 and the electric motor 10 or the angle encoder 16 in order to control or regulate the electric motor 10 in accordance with the processing data which is present in the control device 9 and to supply electrical energy from the rechargeable battery 5 to this electric motor and to the angle encoder 16.

A preferably cable-bound connection 24 or a data line 24 by means of which data and/or signals can be interchanged between a second measuring device 23 and the control device 9 is preferably likewise present between said components. As a result, the second measuring device 23 can substantially continuously transmit the measurement data ascertained by it or ascertained actual processing parameters to the control device 9 which compares said measurement data or actual processing parameters with the setpoint processing parameters which are stored in the preferably integrated memory device (not shown here) preferably by means of an integrated comparison device (not shown here) in order to correct the movements of the working head 13 by, for example, renewed adjustment of the rotation speed.

The individual devices, for example the control device 9, the display device 11, the input device 15, the radio device 8 or the radio module 8, the first measuring device 16 and the second measuring device 23, the drive electronics system 18, the electric motor 10 and/or the gear mechanism 22, are fed with electrical energy or power by the rechargeable battery 5 in order to fulfill their functions or to perform their work. For this purpose, the individual devices listed above are connected to the rechargeable battery 5 by means of electrical power lines (not shown here).

The entire control system and the controlled drives are surrounded by a housing 21 which protects said control system and drives against soiling and destruction or damage.

FIG. 2 shows an exemplary screwing curve 40 in a coordinate system. In said coordinate system, the torque is shown on the ordinate. The unit in which the torque is given is preferably a generally used unit, for example Nm. In this example, a time-dependent component is plotted on the abscissa. Said component can be, for example, the time after the screwing process is started. However, angle values, a sample rate or others, for example, are also possible. Said figure also shows, by way of example, how the shown screwing curve 40 can be divided into individual stages. Possible points of separation are possible in the positions identified by vertical dashed lines. It is also possible to subdivide the individual stages into smaller segments by inserting further separating lines 41. This may be advantageous, for example, when a stage is very long and the microprocessor in the evaluation module 2 would require a long time to calculate all the pairs of values in this stage. These stages can be described by simple mathematical formulae, so that all the pairs of values of the respective stage can be back-calculated merely by transmitting a few parameters. Both linear stage profiles and also curved profiles (not shown) are possible in this case. However, a precondition is that each stage is inherently continuous, so that it can be described by a single mathematical formula. By way of example, the transmission of data which describes the gradient and the duration is sufficient for linear stages.

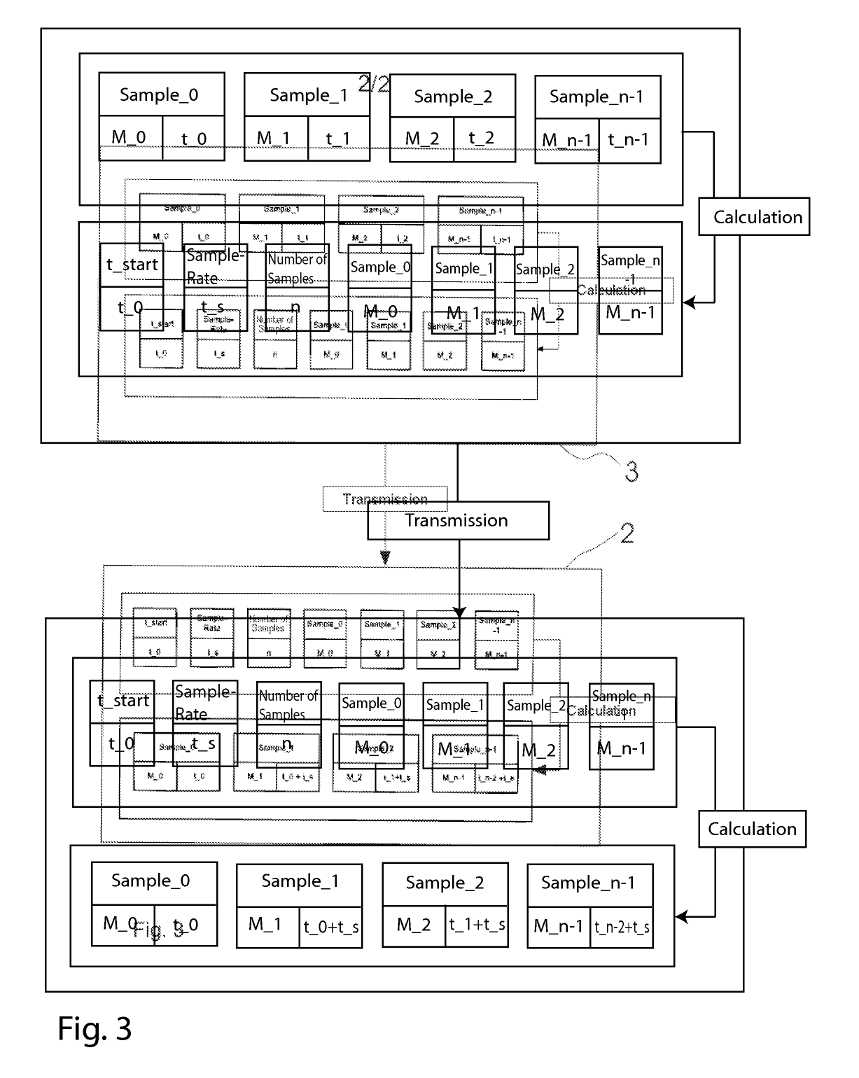

FIG. 3 shows a schematic flowchart for calculating data, transmitting said data and the back-calculation. The ascertained data which characterizes the screwing curve is uncounted in the screwing spindle module 3 and prepared for transmission to the evaluation module 2. In the example shown, the screwing curve comprises a number n of points which are identified as Sample_0-Sample_n-1. Each of these points of the screwing curve is characterized by a torque M_n and a time t_n. Each of these torque/time pairs has a certain size. For example, each of these pairs could have a size of 8 bytes. A specific bandwidth is required to transmit this volume of data and a corresponding amount of energy also has to be expended for transmission purposes.

In order to reduce the volume of data which is to be transmitted, it is advantageous to compress the data as early as in the screwing spindle module 3. In the example shown, this compression involves a start time (t_start t_0) and a sample rate (Sample Rate t_s) and the number of pairs of values (Number of Samples n) being ascertained for the purpose of transmitting the screwing curve. Each of these data packets is, in turn, of a size which, however, is smaller than the size of the volume of data of the torque/time pairs. For example, a data packet for the start time, sample rate and number of pairs of values can comprise, for example, 4 bytes in each case.

The volume of the data which is to be transmitted and/or of the calculated curve can be reduced once again by compression with a compression tool, for example the zip file format.

In addition to these three values which are constant for the entire screwing curve, further values are specified for each data point in order to be able to reconstruct the screwing curve. However, a single value for each data point is sufficient for this purpose. This value (M_n) which is calculated for each data point (Sample_n) in turn is likewise smaller than the data volume of the torque/time pairs. The size of this data packet could also be, for example, 4 bytes. Accordingly—apart from the data volume which is required for the start time, sample rate and number of pairs of values—it is possible to reduce the data volume for each point of the screwing curve. In said example, the data volume for each point of the screwing curve can be halved, for example. This shows that (given the same data volume for the start time, sample rate and number of pairs of values and each individual calculated value for each screwing curved point (M_n)) of, for example, 4 bytes, the data volume can be reduced (to 3×4+4×4=28 bytes) even in the case of a screwing curve comprising four pairs of values (4×2×4=32 bytes).

After calculation of this compressed data, said data is transmitted by the screwing spindle module 3 to the evaluation module 2. The duration and therefore the energy expended for transmission at the same bandwidth can be reduced by reducing the data volume.

After the data is received, the screwing curve or the pairs of values which characterize said screwing curve are back-calculated in the evaluation module 2. Since t_0 and the sample rate are known (and are constant over the entire screwing curve), the corresponding t_n value can be associated with each of the transmitted data points M_n. Complete reconstruction (back-calculation of the screwing curve from the compressed data is therefore possible in the evaluation module 2 by virtue of this method.

The applicant reserves the right to claim all the features disclosed in the application documents as being essential to the invention provided that they are novel over the prior art individually or in combination.

### LIST OF REFERENCE SYMBOLS

1. Screwing system
2. Control module
3. Screwing spindle module
4. Communication devices 4
5. Rechargeable battery
6. Communication channel
7. Cable-bound line
8. Radio module
9. Processing and control device
10. Electric motor
11. Display unit
12. Angle head
13. Working head
14. Memory device
15. Input device
16. Measuring device, for example angle encoder
18. Drive electronics system
19. Two-part line
20. Line
21. Housing
22. Gear mechanism
23. Second measuring device
24. Cable-bound connection or data line
40. Screwing curve
41. Separating lines

1. A method for using a rechargeable battery-operated screwing system comprising:
wireles sly transmitting data for defining screwing curves, between a screwing spindle module and an evaluation module, with communication devices of the rechargeable battery-operated screwing system;
wirelessly transmitting at least two variables which are characteristic of the screwing curve by means of the communication devices; and
modifying, with the screwing spindle module, the data which is to be transmitted by calculating at least one variable which is relevant for characterizing the screwing curve,
wherein the screwing curves describe a screwing process, and
wherein the rechargeable battery-operated screwing system is suitable for establishing screw connections by means of the motor-driven working spindle.

2. The method according to claim 1, wherein:
the screwing curve is divided into individual stages, and
characteristic values for the start angle and start time or sample rate are in each case transmitted for each stage.

3. The method according to claim 1, wherein:
a data record which is to be transmitted is calculated from the screwing curve by the screwing spindle module in a first step, and
this data which is characteristic of the screwing curve is transmitted to the evaluation module in a subsequent second step.

4. The method according to claim 1, wherein the wireless transmission of the data between the communication devices is interrupted after the data for defining a screwing curve has been transmitted, as a result of which energy consumption by the communication devices for transmitting the data which is required for defining a screwing curve is reduced.

5. The method according to claim 1, wherein pairs of torque/angle and/or torque/time values of a screwing curve within a stage with a constant rotation speed and sample rate are calculated from wirelessly transmitted data for the start angle and start time.

6. The method according to claim 1, wherein the time which is taken for transmitting the data which is required in the evaluation module for calculating the pairs of torque/angle and/or torque/time values which characterize the screwing curve is reduced compared with that for transmitting the pairs of torque/angle and/or torque/time values at the same bandwidth.

7. A rechargeable battery-operated screwing system which is suitable for establishing screw connections by means of a motor-driven working spindle, comprising:
communication devices for wirelessly transmitting data for defining screwing curves, which describe a screwing process, between a screwing spindle module and an evaluation module,
wherein the communication devices have means for wirelessly transmitting at least two variables which are characteristic of the screwing curve, and
wherein the evaluation module has a device for calculating from the data at least one further variable which is relevant for the screwing curve.

8. The rechargeable battery-operated screwing system according to claim 7, wherein the wireless data transmission between the communication devices is bidirectional.

9. The rechargeable battery-operated screwing system according to claim 7, further comprising:
a device which comprises a microcontroller and which is suitable for dividing a prespecified screwing curve into individual stages which can be defined in each case by the start angle and the start time or sample rate.

10. The rechargeable battery-operated screwing system according to claim 7, wherein the evaluation module has a device by means of which individual stages of a screwing curve and/or the prespecified screwing curve can be calculated from the start angle and start time or sample rate.

11. The rechargeable battery-operated screwing system according to claim 7, wherein the data which can be provided by the screwing spindle module for the wireless data transmission and is constant for and characteristic of individual stages of a screwing curve comprises a start angle value, a rotation speed value and a sample rate value.
